(19) United States
(12) Patent Application Publication
(10) Pub. No.: US 2025/0123419 A1
(43) Pub. Date: Apr. 17, 2025

(54) MATERIAL YIELD SENSOR ASSEMBLY AND METHOD OF MONITORING SAME

(71) Applicant: Silverleafe Global Ag Tech, LLC, Memphis, TN (US)

(72) Inventors: William Colley, Memphis, TN (US); Alex Thomasson, Memphis, TN (US); Ruixiu Sui, Memphis, TN (US)

(21) Appl. No.: 18/488,767

(22) Filed: Oct. 17, 2023

(51) Int. Cl. G01V 8/12; A01D 46/08; G08B 5/36

(52) U.S. Cl. CPC G01V 8/12; A01D 46/085; G08B 5/36

(57) ABSTRACT

A method of monitoring a material yield sensor assembly for upward baseline drift, the method comprising steps of receiving a signal representing a plurality of raw baseline datapoints from the material yield sensor assembly, passing the raw baseline datapoints through an IIR filter thereby producing a plurality of filtered datapoints, fitting the filtered datapoints to a curve via a curve fitter thereby producing a plurality of fitted datapoints, and generating an alarm indicating the material yield sensor assembly should be serviced if a fitted datapoint of the plurality of fitted datapoints is greater than a first threshold.

### BACKGROUND

Cotton yield sensor assemblies are often used for determining a yield (e.g., quantity or mass flow) of cotton being harvested. Signals generated by such cotton yield sensor assemblies have a wide dynamic range over various field conditions. A single fixed gain, though simple and easy to implement, typically loses information in some field conditions due to signal clipping while having suboptimal signal resolution in other field conditions. An alternative is to increase an analog-to-digital converter (ADC) resolution for smaller signals. Unfortunately, that requires a higher-resolution ADC module in addition to a built-in ADC module, which adds complexity and cost.

Cotton yield sensor assemblies also accumulate debris (e.g., dust, sap, or dirt), which causes upward baseline drift in their yield signals over time. Eventually the upward baseline drift causes yield data to be inaccurate enough to be significant. Unfortunately, the drift is gradual enough to be unnoticeable until substantial amounts of unrepeatable crop data has been obtained. Furthermore, identifying a service condition only when the yield data is determined to be significantly inaccurate results in substantial machine downtime.

The background discussion is intended to provide information related to the present invention which is not necessarily prior art.

### SUMMARY

The present invention solves the above-described problems and other problems and provides a distinct advance in the art of material yield sensor assemblies. More particularly, the present invention provides a material yield sensor assembly that optimizes signal integrity versus signal resolution and a method of monitoring a material yield sensor assembly for upward baseline drift.

An embodiment of the invention is a material yield sensor assembly having an autoranging gain control. The material yield sensor broadly comprises a photodiode and a processing element.

The photodiode is configured to generate a signal representative of an amount of material passing by the photodiode. The photodiode may oppose an LED for targeted light transmission past the material to the photodiode.

The processing element is communicatively connected to the photodiode and is configured to convert the signal from an analog form to a digital form, determine a clipping density of the signal, decrease a gain of the signal if the clipping density is greater than a first threshold, and increase the gain of the signal if the clipping density is less than a second threshold. This minimizes information loss (i.e., maximizes signal integrity) while retaining signal resolution.

Another embodiment is a method of monitoring a material yield sensor assembly for upward baseline drift caused by accumulation of debris on a lens of the material yield sensor assembly. The method broadly comprises steps of receiving a signal representing a number of raw baseline datapoints from the material yield sensor assembly, passing the raw baseline datapoints through an infinite impulse response (IIR) filter thereby producing a number of filtered datapoints, and fitting the filtered datapoints to a curve via a curve fitter thereby producing a number of fitted datapoints. The method further comprises a step of generating an alarm indicating the material yield sensor assembly should be serviced if a fitted datapoint is greater than a first threshold.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of a material yield system constructed in accordance with an embodiment of the invention;

FIG. 2 is a schematic diagram of certain components of a material yield sensor assembly of the material yield system of FIG. 1;

FIG. 3 is a schematic diagram of certain components of the material yield sensor assembly of FIG. 1;

FIG. 4 is a graph depicting certain signal outputs of the material yield sensor assembly of FIG. 1;

FIG. 5 is a flow diagram of certain method steps in accordance with an embodiment of the invention; and

FIG. 6 is a flow diagram of certain method steps in accordance with another embodiment of the invention.

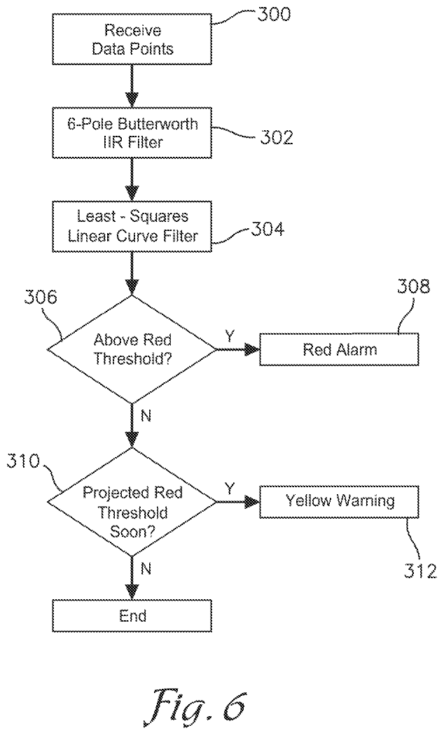

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

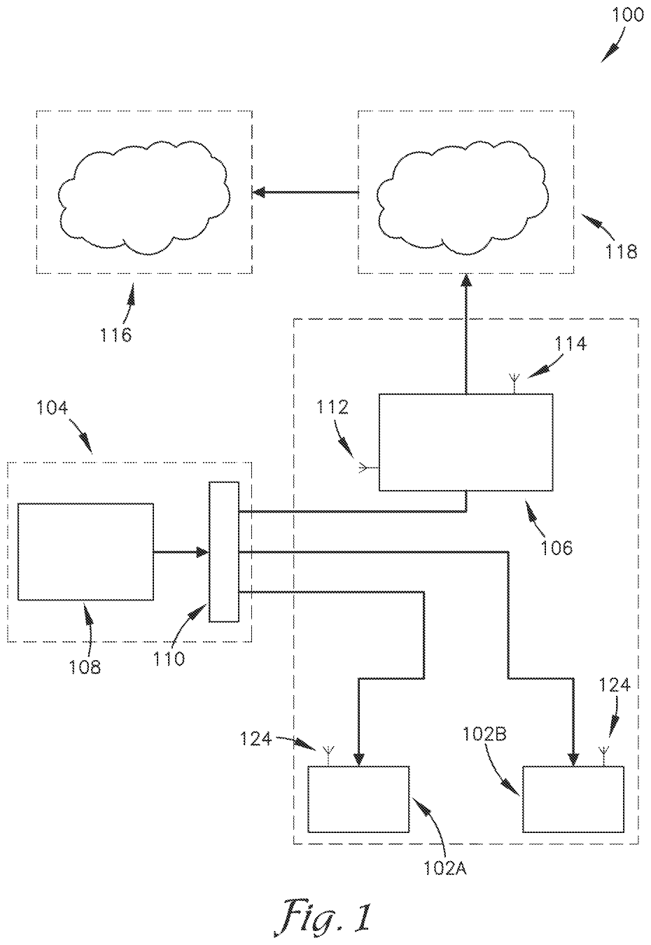

Turning to FIG. 1, a set of material yield sensor assemblies 102A,B constructed in accordance with an embodiment of the invention is illustrated. The material yield sensor assemblies 102A,B may be part of a material yield system 100 used for harvesting cotton or handling other materials of which a yield (e.g., quantity or mass flow) is to be determined. The material yield system 100 in turn broadly comprises the aforementioned material yield sensor assemblies 102A,B, an agricultural implement 104, and a mobile device 106. The agricultural implement 104 and mobile device 106 will be discussed in detail first.

In addition to harvesting cotton (or handling other materials), the agricultural implement 104 provides electrical power to the material yield sensor assemblies 102A,B and the mobile device 106. To that end, the agricultural implement 104 may include a battery 108 and a power distribution unit 110. The agricultural implement 104 may be a cotton harvester, cotton stripper, cotton picker, tractor (pulling a cotton harvesting implement), or the like.

The battery 108 provides electrical power to the sensor assemblies 102A,B and the mobile device 106. The battery 108 may be a primary battery of the agricultural implement 104 (and hence used by electronic systems of the agricultural implement 104) or an auxiliary battery dedicated to powering the sensor assemblies 102A,B and the mobile device 106.

The power distribution unit 110 directs electrical power from the battery 108 to the sensor assemblies 102A,B and the mobile device 106. The power distribution unit 110 may be electrically connected to the material yield sensor assemblies 102A,B via 12 VDC wire cables or the like. The power distribution unit 110 may be connected to the mobile device 106 via a removable USB power cable or the like.

The mobile device 106 may be a smartphone, tablet, laptop computer, personal digital assistant, or the like. In one embodiment, the mobile device 106 is a Samsung A32. The mobile device 106 may have a first antenna (e.g., Bluetooth Low Energy (BLE) antenna 112) for wirelessly communicating with the material yield sensor assemblies 102A,B and a second antenna (e.g., cellular/GPS antenna 114) for wirelessly communicating with a cloud computing network 116 optionally via a third party cloud computing network 118 (e.g., the Google Cloud Platform or Microsoft Azure Cloud Platform). The mobile device 106 may monitor upward baseline drift of signals generated by the material yield sensor assemblies 102A,B, which will be described in more detail below.

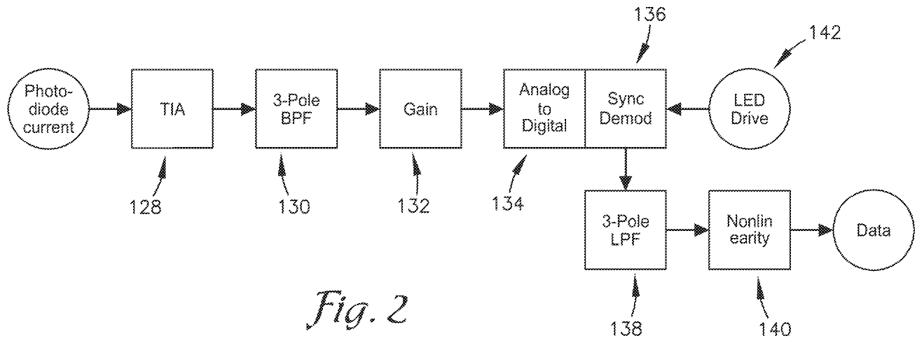

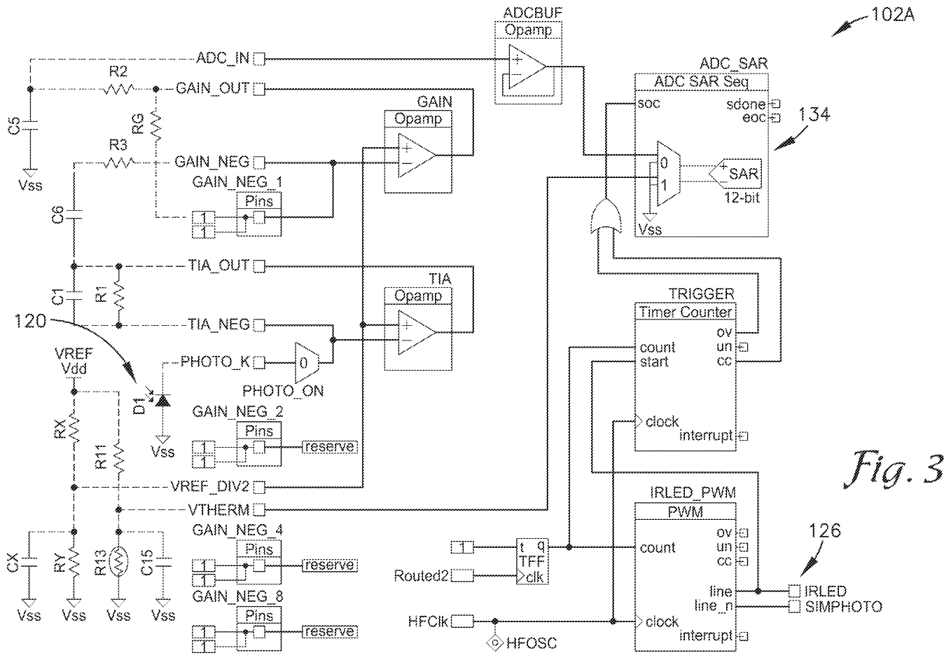

Turning to FIGS. 2 and 3, the material yield sensor assemblies 102A,B are substantially similar to each other so only material yield sensor assembly 102A will be described in more detail. The material yield sensor assembly 102A may include a photodiode 120, a processing assembly 122, and an antenna 124.

The photodiode 120 receives light from a light emitting diode (LED) 126 or other light source and outputs a current signal, which may be proportional to intensity of light from the LED 126 as perceived by the photodiode 120. To that end, the photodiode 120 may be positioned opposite the LED 126 in or near a chute so that material (e.g., cotton) obstructs the light of the LED 126 from reaching the photodiode 120.

The LED 126 may be positioned opposite the photodiode 120 in or near the chute and may project a light beam toward the photodiode 120. The LED 126 may be tuned to a specific wavelength. To that end, the LED 126 may produce light in at least one of the visible and infrared (IR) spectrum. In one embodiment, the LED 126 is an IR LED. The LED 126 may be part of the material yield sensor assembly 102A or may be an external component.

The processing assembly 122 may be or may include an integrated chip (IC) or similar electronic component and may include several physical or firmware modules. Specifically, the processing assembly 122 may include, implement, or interact with a transimpedance amplifier module 128, a 3-pole band-pass filter module 130, a gain module 132, an ADC module 134, a synchronous demodulation module 136, a 3-pole low-pass filter module 138, and a nonlinearity module 140. The processing assembly 122 may also include, implement, or interact with an LED drive 142.

The processing assembly 122 may include a processing element (e.g., microcontroller) configured to implement aspects of the present invention with one or more computer programs stored in or on computer-readable medium residing on or accessible by the processing element. Each computer program preferably comprises an ordered listing of executable instructions for implementing logical functions in the processing element. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a removable memory, and a solid state drive.

The transimpedance amplifier module 128 translates the current output of the photodiode to a voltage output. The transimpedance amplifier module 128 may include an operational amplifier and may be electronically connected to the photodiode 120.

The 3-pole band-pass filter module 130 allows frequencies of the signal from the transimpedance amplifier module 128 within a certain passband to pass therethrough while attenuating frequencies above and below the passband. The 3-pole band-pass filter module 130 may include an operational amplifier.

The gain module 132 amplifies the signal. The gain module 132 may typically utilize an op amp.

The ADC module 134 converts the analog signal to a digital signal and may be built into a radio module integrated chip (IC). Conversions of the ADC module 134 may be triggered in a fixed time relationship to the LED drive 142 such that the conversions alternate between converting positive and negative peaks of the amplified photodiode current.

The synchronous demodulation module 136 converts peak-to-peak amplitude to DC level in the digital domain for differencing successive conversions. This module may be an integral portion of the ADC module 134.

The LED drive 142 may be established by a timer on the processing assembly 122 that is referenced to the processing assembly's crystal. Frequency is thus tightly controlled without trimming.

The 3-pole low-pass filter module 138 allows frequencies below a certain threshold to pass while attenuating frequencies above the threshold. The 3-pole low-pass filter module 138 may be implemented in the digital domain via firmware.

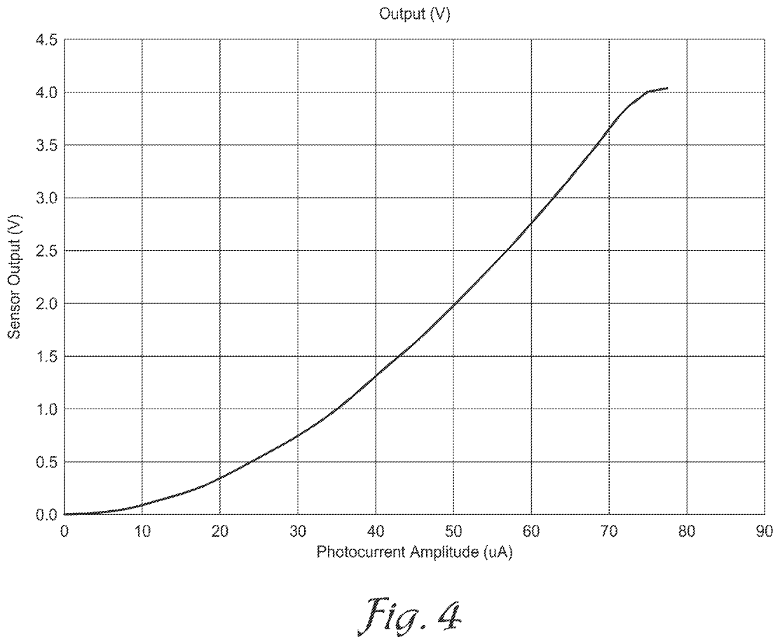

The nonlinearity module 140 extricates the signal from its non-linear form (see FIG. 4) into usable data. The nonlinearity module 140 may be implemented in the digital domain via firmware.

The antenna 124 allows the material yield sensor assembly 102A to wirelessly communicate with the mobile device 106. To that end, the antenna 124 may be a bluetooth Low Energy (BLE) antenna, radio frequency identification (RFID) antenna (e.g., a near field communication (NFC) antenna), or the like.

### Gain Control

Signals generated by the material yield sensor assembly 102A may have a wide dynamic range in peak amplitude over various field conditions. To manage this, signals may be subjected to autoranging in which amplifier gain may be adjusted to span a narrower input signal range when the signals are small and a wider range when the signals are large. This keeps a weight of a least-significant bit of the ADC module 134 from becoming too large a fraction of the signal amplitude when signals are small while allowing the ADC module to span larger signal ranges. Autoranging may be performed via the aforementioned radio module integrated chip (IC), which may have adequate resources remaining to implement it.

Binary-weighted gains of 1X, 2X, 4X, and 8X relative to the original amplifier gain can be accommodated. On the other hand, it may be desirable to obscure such range shifting, but this can be achieved by increasing a resolution available in the data pathway from the material yield sensor assembly 102A to the mobile device 106 by a number of bits (e.g., 4 bits). Gain control input thus may be a stream of 16-bit unsigned numbers representing peak-to-peak amplitude of the AC coupled, detected, filtered, and amplified signal from the photodiode 120.

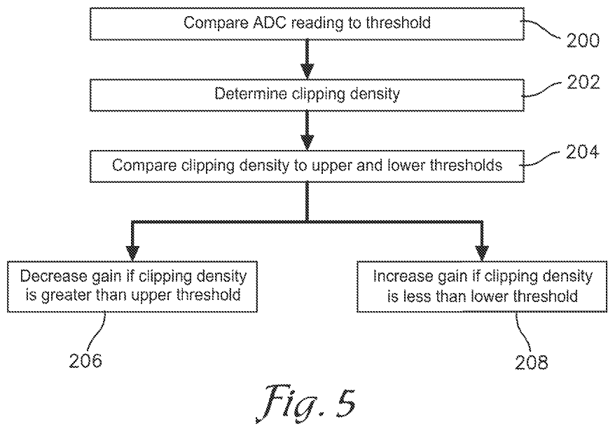

Turning to FIG. 5, the following may facilitate determining when to increase or decrease amplifier gain. First, compare each ADC reading (the gain control input) to a fixed threshold near full scale, as shown in block 200. Each reading will result in a “too high” (i.e. clipping is present) or “not too high” determination. If a reading is too high, a numerical deposit is added to a numerical register, thereby making the numerical register increase linearly for instances of “too high” readings. Meanwhile, the numerical register decays exponentially over time.

A density of too-high readings over time may be determined via an IIR filter, as shown in block 202. This is economical in its use of processing and memory resources. If the density of too-high readings exceeds a first threshold (e.g., 2% for 15 consecutive seconds), the amplifier gain is decreased to increase the ADC span, as shown in blocks 204 and 206. On the other hand, if the density of too-high readings falls below a second threshold (e.g., 0.25% for 15 consecutive seconds), the amplifier gain is increased to decrease the ADC span, as shown in blocks 204 and 208.

In other words, it is desirable to have clipping at a certain rate (or range or rates). Too much clipping results in too much information lost, while too little clipping results in suboptimal resolution for most signals.

The above may be implemented according to a numeric model. Let the frequency of arriving numbers be F. Let the fraction of the numbers that clip be C. Note that C is inclusively between 0 (no numbers clip) and 1 (all numbers clip). At each instance/point of clipping, a numerical deposit (of a value V_{c}) is added to the numerical register.

$$Input Flow Rate = C \times F \times {V}_{c}$$

Let the value currently in the register be V_{b}. Let the percentage of the value removed at each point be P, which is between 0 (no amount removed) and 1 (the full value currently in the numerical register is removed).

$$Output Flow Rate = F \times {V}_{b} \times P$$

At equilibrium, the input and output flow rates are equal.

$$C \times F \times {V}_{c} = F \times {V}_{b} \times P$$

Solving for C as a function of V_{b} yields:

$$C = \frac{{V}_{b} \times P}{{V}_{c}}$$

Exemplary values may be as follows: V_{c}=1048576. P= 1/4096, with lower and upper limits on V_{b} being 626000 and 8100000. This corresponds to a clipping density of between approximately 0.015% and 0.19% (i.e., a clipped instance every 6861 to 530 points on average. Note that these are samples of raw data, not 1 sample/second block averaged data.

Using a 32-bit number for the numerical register can lead to an undesirable situation-if several clipped instances happen in rapid succession, the numerical register may be filled far above the upper limit. It would take a long time to return back to equilibrium even if the analog gain is lowered to eliminate clipping entirely. This would lead to poor capture behavior of a desired gain value. Thus, an upper limit on the capacity of the numerical register may be established. In this example, V_{b} is not allowed to exceed 9148576 (i.e., the upper limit plus V_{c}).

After a gain change is made to adjust clipping density (C), some time must pass for the numerical register to reach a new equilibrium. Thus, the gain may be kept constant for an amount of time (e.g., 30 seconds) after the gain change is made. After the amount of time has passed, V_{b} may be evaluated against its limits again.

Furthermore, chasing short-term excursions in V_{b} is preferably avoided. To that end, gain changes may not be made unless V_{b} has been above the upper limit or below the lower limit for an amount of time (e.g., 30 seconds).

Additional considerations for achieving the above in digital form will now be described in more detail. Raw ADC readings are 12 bits wide and are scaled after they're obtained from the ADC to reflect a current amplifier gain setting, which may occur via an ADC interrupt handler. Since the possible gain settings are 1X, 2X, 4X, and 8X, this widens the ADC readings to 16 bits. For example, if an analog strip gain is set to a next-to-lowest setting, variable gain may have a value of 1. The net result of this shifting is the 12 bit ADC reading is shifted left three places. That gives a 15 bit result with the ADC reading bits in the most significant 12 bits and three zeros in the least significant three bits. If the analog strip gain is at a highest setting, variable gain has a value of 3 and then net result of this shifting is one place to the left. This gives a 13 bit result that spans the first eighth of the widened 16 bit range with a resolution of two counts (only one zero bit).

Input digitized peak-to-peak amplitudes are evaluated at every switching cycle (e.g., at 5250 samples/second). Specifically, the processing assembly 122 acquires ADC samples and performs a form of synchronous demodulation. Peak and valley amplitudes are then differenced to determine peak-to-peak amplitude. The signal may then go through a number of digital signal processing stages.

First, scaled ADC readings are fed to a peak detector with a decay time constant of approximately 37.5 ms. The peak detector may not work without significant fraction retention. To overcome this, the peak detector may have a numerical register that is 32 bits wide and a 16 bit left shift may be applied (adding 16 zeroed fractional bits) to the peak-to-peak amplitude before it is fed to the peak detector. The peak detector output may then be scaled by a 13 bit right shift to truncate most of the fractional bits before further processing.

Next, the output of the peak detector may go through a cascade of three single-pole IIR low-pass filters with corner frequencies of approximately 579 Hz, approximately 112 Hz, and approximately 6.55 Hz, respectively. A further stage after the cascade of three single-pole IIR filters may be decimation down to a set sample rate.

Clipping evaluation as described above may be performed between any one of these stages. If the output of the third IIR low-pass filter is tapped (i.e., after the fourth stage described above), low bandwidth may flatten the peaks such that a very high clipping density may need to be present to even notice any clipping at all. In contrast, if the output of the peak detector is tapped (i.e., after the first stage described above), clipping evaluation could be vulnerable to noise peaks. An advantageous compromise is to tap the output of the second IIR low-pass filter stage (i.e., after the third stage described above) to evaluate clipping. Tapping after other stages can easily be used as needed.

Two individual ADC readings (one reading representing a peak and another reading representing a valley) are acquired every cycle of the LED output. Note that the LED output may be chopped at for example approximately 5.25 kHz. Further processing at this rate is not necessary after peak detection and filtering of individual data samples, and foregoing such further processing prevents potential compute load problems. The filtered data samples can be analyzed at a lower rate because the filtering removes high-frequency components. The above-described gain control may be implemented each time a sample is sent to the mobile device 106, which may be no more often than approximately 100 times per second.

An objective of the gain control is to dictate saturation of the ADC module 134, so the gain control must operate on peak-to-peak amplitude values that are not scaled by the amplifier strip gain (i.e, the peak detector bit shifting described above). Thus, the effect of this scaling must be reversed in the ADC interrupt handler, which can be achieved via a bit shift that undoes any previous bit shift.

Furthermore, the effect of the gain control determination is not applied directly to the analog strip. Doing so could change the amplifier gain between the peak and valley acquisitions of a single LED cycle, which would corrupt the peak-to-peak amplitude value. Instead, any gain change may be temporarily given a pending status and applied between cycles.

Nonlinearity

Amplification from the transimpedance amplifier module 128 may follow a nonlinear curve as shown in the plot of FIG. 4. Generally speaking, the amplifier gain may span the entire curve, but the amplifier gain may be changed to span subranges of this plot as described above. This introduces the following problem. If a signal's amplitude spans only the first eighth of the curve, for example, the ADC loses three bits of resolution over that smaller range. As another example, an amplifier gain twice as high (as normal gain) makes the ADC span only the portion of the plot up to 40 microamps. This may be handled via a lookup table with an increased resolution at low amplitudes.

In one embodiment, the output from the third IIR filter (which may be a 19-bit number) is pushed through the following input/output lookup tables to maintain the nonlinearity:

TABLE 1
(input):

| | | | | | | | | | |
|---|---|---|---|---|---|---|---|---|---|
| 0 | 1664 | 3376 | 5072 | 6784 | 8464 | 10176 | 11888 | 13584 | 15304 |
| 16992 | 18688 | 20392 | 22096 | 23816 | 25472 | 27200 | 28912 | 30616 | 32304 |
| 34016 | 35712 | 37424 | 39128 | 40784 | 42512 | 44216 | 45928 | 47640 | 49320 |
| 51032 | 52744 | 54448 | 57840 | 61256 | 64632 | 68016 | 71448 | 74848 | 78296 |
| 81680 | 85096 | 88504 | 91872 | 95296 | 98680 | 102088 | 105504 | 108920 | 115672 |
| 122528 | 129392 | 136208 | 142960 | 149768 | 156512 | 163392 | 170176 | 177024 | 183856 |
| 190712 | 197432 | 204240 | 210920 | 217888 | 231496 | 245088 | 258768 | 272448 | 285920 |
| 299496 | 313184 | 326736 | 340408 | 354072 | 367680 | 381288 | 394864 | 524287 | |

TABLE 2
(output):

| | | | | | | | | | |
|---|---|---|---|---|---|---|---|---|---|
| 0 | 9 | 33 | 75 | 134 | 210 | 302 | 411 | 537 | 681 |
| 842 | 1018 | 1212 | 1424 | 1651 | 1896 | 2158 | 2434 | 2729 | 3043 |
| 3371 | 3715 | 4078 | 4458 | 4853 | 5266 | 5694 | 6137 | 6602 | 7082 |
| 7575 | 8086 | 8617 | 9724 | 10893 | 12135 | 13433 | 14804 | 16238 | 17727 |
| 19296 | 20915 | 22606 | 24361 | 26166 | 28050 | 29985 | 31988 | 34050 | 38355 |
| 42905 | 47691 | 52709 | 57953 | 63439 | 69154 | 75080 | 81225 | 87574 | 94148 |
| 100937 | 107928 | 115125 | 122514 | 130106 | 145848 | 162373 | 179607 | 197540 | 216197 |
| 235512 | 255431 | 276046 | 297239 | 319008 | 341460 | 364439 | 386926 | 601300 | |

The automatic gain control described above ensures the largest possible range of table input values, and hence table output values, is spanned without excessive clipping. For example, if the gain is on the next-to-lowest setting, the table input spans 0 through (2¹⁹)/2 (i.e., the first half of the input table). Similarly, the table output comes from the first half of the output table.

The table entries are not evenly spaced and do not need to be. It is desirable to have frequent table entries for the first parts of the tables when operating at high gain settings. The nonlinearity straightens out later in the tables, so less frequent table entries can be tolerated there. This saves time searching the tables. Furthermore, data manipulation techniques such as rounding, interpolation, and extrapolation, and table lookup techniques such as binning may be utilized for more effective and efficient use of the tables.

An additional lookup table may be used to compensate for temperature fluctuations in the material yield sensor assemblies 102A,B. Such temperature fluctuations change the efficiency of the LED 126. A temperature measurement can be obtained from a heater loop (or an additional temperature measurement can be taken) to determine an actual operating temperature. If the actual operating temperature is different than a regulation or standard temperature, a gain correction may be applied to values obtained from Table 2 (output table). An exemplary temperature compensation table is as follows:

TABLE 3
(temperature compensation):

| | | | | | | | | | |
|---|---|---|---|---|---|---|---|---|---|
| 2062 | 2062 | 2061 | 2060 | 2059 | 2057 | 2056 | 2055 | 2054 | 2053 |
| 2052 | 2051 | 2050 | 2050 | 2049 | 2049 | 2049 | 2048 | 2048 | 2048 |
| 2048 | 2048 | 2048 | 2049 | 2049 | 2050 | 2051 | 2052 | 2054 | 2055 |
| 2057 | 2059 | 2061 | 2063 | 2066 | 2069 | 2072 | 2076 | 2080 | 2084 |
| 2088 | 2093 | 2098 | 2103 | 2108 | 2112 | 2114 | 2114 | 2111 | 2103 |

Furthermore, as with the input/output tables, data manipulation techniques such as rounding, interpolation, and extrapolation, and table lookup techniques such as binning may be utilized for more effective and efficient use of the temperature compensation table.

Material yield may then be determined according to outputs (modified as described above) of the material yield sensor assemblies 102A,B. For example, “S1” may be the output (in volts) of material yield sensor assembly 102A, “S2” may be the output (in volts) of material yield sensor assembly 102B, and “C” may be a coefficient equating to pounds per volt (which may need to be determined by field tests). “Speed” may be a picker travel speed (in mph or converted to mph), “Travel_Time” may be a time interval between two data points (e.g., 1 second, which may need to be determined by field tests), and “Swath” (in inches) may equal row spacing multiplied by a number of rows to pick. Row spacing may vary (e.g., 38 inches or 40 inches in the U.S.). The number of rows may be for example 6 for a 6-row picker, 4 for a 4-row picker, and 2 for a 2-row picker. “Yield” may mean pounds per acre. For this example, the following equation may be used to calculate material yield:

$$Yield = \frac{356400 \times C \times ( S 1 + S 2 )}{Speed \times Swath \times Travel\_Time}$$

The above-described material yield system 100 provides several advantages. For example, the material yield system 100 controls material sensor gain so as to maintain a high analog signal amplitude without excessive amounts of clipping. The material yield system 100 evaluates clipping in an effective way that has low vulnerability (or even no vulnerability) to noise peaks. The material yield system 100 also optimizes processing resources of its various components to minimize cost and complexity. The material yield system 100 also implements lookup tables for improved results including for mitigating the effects of temperature fluctuations.

### Upward Baseline Drift

Accumulation of debris (e.g., dust, sap, or dirt) on the material yield sensor assemblies 102A,B often causes upward baseline drift of signals generated by the material yield sensor assemblies 102A,B. Such upward baseline drift may be monitored by the mobile device 106 and/or other processing elements of the present invention. Alerts related to the upward baseline drift may be provided to a sensor system operator so that sensor maintenance or other corrective actions can be taken. For example, a yellow warning may be activated/active if the baseline will exceed a limit value soon (e.g., 15-30 minutes) and a red alarm may be activated/active if the baseline has exceeded the limit value. Monitoring signals of the material yield sensor assemblies 102A,B will now be described in detail.

Input data to upward baseline drift monitoring may be a sequence of raw baseline values determined by a mobile application on the mobile device 106, for example. This sequence of values may be denoted “B_raw[i]”. The raw baseline values may arrive at approximately one value per second.

Two internal functional blocks—a 6-pole Butterworth IIR filter and a least-squares linear curve fitter—may be utilized for analyzing the input data. These blocks may presume at least double-precision floating-point values. Such values should be readily handled by a processor of the mobile device 106.

The 6-pole Butterworth IIR filter aims to present a frequency response that is as flat as possible in its passband (i.e., maximally uniform sensitivity for passing frequencies) and will be described first. Other filters that achieve this objective may also be used. A parameter to the 6-pole Butterworth IIR filter may be a filter coefficient “coeff”, which may be for example 1/64. Intermediate variables may be an array of six values “IIR”. Initialization may be performed by setting all elements of array IIR to B_raw[0]. As each value B_raw[i] arrives, the array IIR may be filled out as follows:

IIR[0] += (B_raw[i] − IIR[0]) * coeff
IIR[1] += (IIR[0]−IIR[1]) * coeff
IIR[2] += (IIR[1]−IIR[2]) * coeff
IIR[3] += (IIR[2]−IIR[3]) * coeff
IIR[4] += (IIR[3]−IIR[4]) * coeff
IIR[5] += (IIR[4]−IIR[5]) * coeff

The 6-pole Butterworth IIR filter then outputs B_filtered[i]=IIR[5].

The least-squares linear curve fitter creates a linear curve according to a set of data points (in particular, the filtered datapoints of the 6-pole Butterworth IIR filter). Other curve fitters may also be used. A parameter to the least-squares linear curve fitter may be a number of data points to fit “FitSize”, which may be approximately 1200 data points. Intermediate variables may be a list of at least the FitSize values, “FitList”. Each element of FitList may contain two values, X and Y. Additional intermediate variables may include values “FitSumX”, “FitSumY”, “FitSumXX”, and “FitSumXY”. Further intermediate variables may include scratch values “denom” (denominator), “slope”, “intercept”, and FitFailed. Initialization may be achieved by clearing FitList and setting FitSumX, FitSum Y, FitSumXX, and FitSumXY to 0.

As each value pair (e.g., point.X and point.Y) arrives, first a determination is made whether a length of FitList is greater than or equal to FitSize. If so, the following may be performed:

```
  FitSumX −= FitList[0].X
  FitSumY −= FitList[0].Y
  FitSumXX −= FitList[0].X * FitList[0].X
  FitSumXY −=FitList[0].X * FitList[0].Y
  Remove element 0 from FitList.
  Append the new value pair to FitList.
  FitSumX += point.X
  FitSumY += point.Y
  FitSumXX += point.X * point.X
  FitSumXY += point.X * point.Y
  denom = FitSumXX * (length of FitList) − FitSumX * FitSumX
  If denom equals 0, then set slope and intercept to 0 and set FitFailed to true.
  Otherwise, perform the following equalities:
  Slope = (FitSumXY * (length of FitList) − FitSumX * FitSumY) / denom
  Intercept = FitSumXY * FitSumX − FitSumY * FitSumXX) / −denom
  Set FitFailed to false.
  The least-squares linear curve fitter provides a slope, an intercept, and a FitFailed
(true or false) indication.
```

Upward baseline drift monitoring and alert generation utilizing the least-squares linear curve fitter and the 6-pole Butterworth IIR filter will now be described in more detail. Parameters to such monitoring may include red alarm threshold “redThreshold” (e.g., 1.75), red alarm hysteresis “redHysteresis” (e.g., 0.1*redThreshold), yellow warning projection time “yellowTime” (e.g., 1800 seconds), and yellow warning stretch time “yellowStretchSamples” (e.g., 600 seconds).

Intermediate variables may include a Boolean value “inRedFail”, an integer value “yellowStretch”, a value “startTime”, an input point “point” (which contains two values X and Y denoted as point. X and point. Y respectively) to the least-squares linear curve fitter, and a scratch value “timeAtFail”.

To begin upward baseline drift monitoring, the 6-pole Butterworth IIR filter and the least-squares linear curve fitter are initialized. Then, startTime is set to a timestamp associated with B_raw[0]. inRedFail is set to false, and yellowStretch is set to 0.

As each baseline value B_raw[i] and its corresponding timestamp time[i] is received (block 300), the following is performed:

Set point.X equal to the time difference time[i]-startTime (in seconds). This provides a temporal reference for the data points.

Next, feed B_raw[i] to the 6-pole Butterworth IIR filter. From this, set point.Y equal to B_filtered[i] from the 6-pole Butterworth IIR filter, as shown in block 302. As described above, this provides improved data for further analysis.

Next, feed point.X and point.Y to the least-squares linear curve fitter, as shown in block 304. This provides a linear curve from which comparisons to alarm thresholds can be made.

If inRedFail=false, then if point.Y >=redThreshold, then set inRedFail to true (block 306), set yellowStretch to 0, and skip the remaining steps. This triggers generation of a red alarm (block 308) to alert the sensor system operator that the material yield sensor assemblies 102A,B should be serviced. Otherwise, if point.Y>=redThreshold-redHysteresis, skip the remaining steps. This prevents hysteresis in the input data from triggering unnecessary alarms or initiating unnecessary computations.

If the least-squares linear curve fitter returns FitFail=false and slope!=0, then set timeAtFail=(redThreshold-intercept)/slope. Then if timeAtFail−point.X>'0 and timeAtFail−point.X<=yellowTime (block 310), set yellowStretch to yellowStretchSamples and skip the remaining steps. This indicates the baseline will likely exceed the threshold within a certain time, such as 30 minutes, and thus triggers generation of a yellow warning.

If yellowStretch>0, set yellowStretch=1. This tolls a temporal length of the yellow warning. In this example, the yellow warning lasts 10 minutes.

Output of upward baseline drift monitoring includes the following: if inRedFail is true, activate the red alarm, as previously shown in block 308 (i.e., the red alarm is active). Otherwise, if yellowStretch>0, activate the yellow warning, as shown in block 312 (i.e., the yellow warning is active). Otherwise, neither the red alarm nor the yellow warning is active. The red alarm and the yellow warning can also be transmitted to other parts of the material yield system 100 such as to the agricultural implement 104, the cloud computing network 116, and/or the third party cloud computing network 118.

Upward baseline drift monitoring provides several advantages. For example, it ensures a sensor system operator can service the material yield sensor assemblies 102A,B before they output unacceptably inaccurate data. It also projects a future time at which the material yield sensor assemblies 102A,B should be serviced via the yellow warning so that harvesting/material handling can continue temporarily and to give the sensor system operator time to prepare for maintenance. This minimizes machinery downtime. Furthermore, upward baseline drift monitoring can be performed via the mobile device 106.

### ADDITIONAL CONSIDERATIONS

This description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. This description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods may be illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as a field programmable gate array (FPGA), to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 110 (f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of monitoring a material yield sensor assembly for upward baseline drift caused by accumulation of debris on the material yield sensor assembly, the method comprising steps of:
receiving a signal representing a plurality of raw baseline datapoints from the material yield sensor assembly;
passing the raw baseline datapoints through an IIR filter thereby producing a plurality of filtered datapoints;
fitting the filtered datapoints to a curve via a curve fitter thereby producing a plurality of fitted datapoints; and
generating an alarm indicating the material yield sensor assembly should be serviced if a fitted datapoint of the plurality of fitted datapoints is greater than a first threshold.

2. The method of claim 1, wherein the curve is linear and includes a slope and an intercept, the method further comprising steps of determining a temporal projection of the plurality of datapoints exceeding the first threshold based on the slope and intercept and generating a warning indicating the material yield sensor assembly should be serviced soon if the temporal projection is less than a second threshold.

3. The method of claim 2, wherein the warning is presented as a yellow warning and the alarm is presented as a red alarm.

4. The method of claim 2, wherein the warning has a temporal length shorter than the temporal projection.

5. The method of claim 2, wherein the second threshold is approximately thirty minutes.

6. The method of claim 2, wherein the warning lasts approximately ten minutes.

7. The method of claim 1, wherein the IIR filter is a 6-pole Butterworth IIR filter.

8. The method of claim 1, wherein the curve fitter is a least-squares linear curve fitter.

9. The method of claim 1, wherein the receiving step is performed in one second intervals.

10. The method of claim 1, further comprising a step of checking whether the fitted datapoint is greater than the first threshold minus a hysteresis value.

11. The method of claim 1, wherein the method steps are performed via a mobile device communicatively connected to the material yield sensor assembly.

12. The method of claim 11, wherein the raw baseline datapoints, filtered datapoints, and fitted datapoints are represented by double-precision floating-point values.

13. The method of claim 1, further comprising a step of wirelessly transmitting a signal representing the alarm to an agricultural implement.

14. The method of claim 1, further comprising a step of wirelessly transmitting a signal representing the alarm to a remote computing device.

15. A method of monitoring a material yield sensor assembly for upward baseline drift caused by accumulation of debris on the material yield sensor assembly, the method comprising steps of:
receiving a signal representing a plurality of raw baseline datapoints from the material yield sensor assembly;
passing the raw baseline datapoints through a 6-pole Butterworth IIR filter thereby producing a plurality of filtered datapoints;
fitting the filtered datapoints to a linear curve via a least-squares linear curve fitter thereby producing a plurality of fitted datapoints; and
generating an alarm indicating the material yield sensor assembly should be serviced if a fitted datapoint of the plurality of fitted datapoints is greater than a first threshold.

16. The method of claim 15, wherein the linear curve includes a slope and an intercept, the method further comprising steps of determining a temporal projection of the plurality of datapoints exceeding the first threshold based on the slope and intercept and generating a warning indicating the material yield sensor assembly should be serviced soon if the temporal projection is less than a second threshold.

17. The method of claim 16, wherein the warning is presented as a yellow warning and the alarm is presented as a red alarm.

18. The method of claim 15, further comprising a step of wirelessly transmitting a signal representing the alarm to an agricultural implement.

19. The method of claim 15, further comprising a step of wirelessly transmitting a signal representing the alarm to a remote computing device.

20. A method of monitoring a material yield sensor assembly for upward baseline drift caused by accumulation of debris on the material yield sensor assembly, the method comprising, via a mobile device, steps of:
receiving a signal representing a plurality of raw baseline datapoints from the material yield sensor assembly;
passing the raw baseline datapoints through a 6-pole Butterworth IIR filter thereby producing a plurality of filtered datapoints;
fitting the filtered datapoints to a linear curve via a least-squares linear curve fitter thereby producing a plurality of fitted datapoints, the linear curve including a slope and an intercept;
generating an alarm indicating the material yield sensor assembly should be serviced if a fitted datapoint of the plurality of fitted datapoints is greater than a first threshold;
determining a temporal projection of the plurality of datapoints exceeding the first threshold based on the slope and intercept;
generating a warning indicating the material yield sensor assembly should be serviced soon if the temporal projection is less than a second threshold, wherein the warning has a temporal length shorter than the temporal projection; and
wirelessly transmitting a signal representing the alarm to at least one of an agricultural implement and a remote computing device.
